(19) United States
(12) Patent Application Publication
(10) Pub. No.: US 2015/0063068 A1
(43) Pub. Date: Mar. 5, 2015

(54) SENSING DEVICE AND POSITIONING METHOD

(71) Applicant: AU Optronics Corporation, Hsin-Chu (TW)

(72) Inventors: Chih-Yuan YU, HSIN-CHU (TW); Fang-Ching LEE, Hsinchu County (TW); Chih-Chiang CHEN, HSIN-CHU (TW)

(21) Appl. No.: 14/456,375

(22) Filed: Aug. 11, 2014

(30) Foreign Application Priority Data
Aug. 28, 2013 (TW) 102130854

(51) Int. Cl. G01S 15/06

(52) U.S. Cl. CPC G01S 15/06
USPC 367/99

(57) ABSTRACT

A sensing device and a positioning method are disclosed. The sensing device is mounted around a display module to detect an object. The display module includes a display screen for displaying an image. The sensing device includes a first sonic wave transceiver, a second sonic wave transceiver, and a control module. The first and second sonic wave transceivers are respectively configured for transmitting a first sonic wave and a second sonic wave, and receiving a first reflected sonic wave and a second reflected sonic wave generated based on the first and second sonic waves, respectively. A frequency of the first and second sonic waves is between 50 KHz and 70 KHz. The control module is configured for controlling the first and second sonic wave transceivers, and for calculating a position of the object relative to the display module based on the first and second reflected sonic waves.

### RELATED APPLICATIONS

This application claims priority to Taiwan Application Serial Number 102130854, filed Aug. 28, 2013, which is herein incorporated by reference.

### BACKGROUND

1. Field of Invention

The present invention relates to a sensing device. More particularly, the present invention relates to a sensing device and a positioning method to perform detection using sonic waves.

2. Description of Related Art

With the progress of display and touch technologies, user-friendly interfaces enabling the communications between electronic systems and users have been extensively applied in different fields, such as cell phones, display panels, tutoring systems, etc. An ultrasonic touch system is a common application of touch technology. The ultrasonic touch system detects the position of an object and generating an instruction corresponding to the position based on the reflected wave generated by the object being detected and intensity of the reflected wave.

Several sensing methods have been developed in the ultrasonic touch systems used in some approaches. One type of ultrasonic touch system includes an ultrasonic transmitter and ultrasonic sensors positioned around the object to be detected. The ultrasonic transmitter transmits a sonic signal to the object to be detected, and the ultrasonic sensors are configured for receiving the sonic signals reflected from the object, so as to calculate and position the relative position of the object. However, in this application, the configuration of positions of the ultrasonic sensors is strictly limited to ensure that each of the ultrasonic sensors is able to receive a single reflected sonic signal. In addition, when there is an excessive number of ultrasonic sensors, the computational complexity of the overall system is too high so that time delays in subsequent executions are caused.

Another type of ultrasonic touch system comprises a plurality of ultrasonic transceivers positioned around the object to be detected. The ultrasonic transceivers are configured for respectively generating sonic signals at the same time so as to monitor the object within a predetermined distance. However, in this system, the system cannot perform the subsequent calculations for positioning unless each of the ultrasonic transceivers has received the individual sonic signal reflected from the object to be detected within the above-mentioned predetermined distance. The positioning update rate of the system is thus not sufficient so that a real-time calculation cannot be provided for the current touch operation.

For the forgoing reasons, there is a need for effectively improving the detection update rate and calculating the position of the object to be detected more efficiently using an ultrasonic wave to perform touch control, which is also the object that the industry eagers to achieve.

### SUMMARY

One aspect of the present disclosure is to provide a sensing device. The sensing device is configured to mount around a display module to detect an object. The display module has a display screen for displaying an image. The sensing device includes a first sonic wave transceiver, a second sonic wave transceiver and a control module. The first sonic wave transceiver is configured for transmitting a first sonic wave. The second sonic wave transceiver is configured for transmitting a second sonic wave. The first sonic wave transceiver and the second sonic wave transceiver are further configured for receiving a first reflected sonic wave and a second reflected sonic wave generated in accordance with the first sonic wave and the second sonic wave, respectively. A frequency of the first sonic wave and the second sonic wave is between 50 KHz and 70 KHz. The control module is electrically coupled to the first sonic wave transceiver and the second sonic wave transceiver, and the control module is configured for controlling the first sonic wave transceiver and the second sonic wave transceiver. The control module further calculates a position of the object relative to the display module in accordance with the first reflected sonic wave and a second reflected sonic wave. By setting the frequency of the first sonic wave and the second sonic wave between 50 KHz and 70 KHz, the first sonic wave transceiver and the second sonic wave transceiver are allowed to receive the first reflected sonic wave and the second reflected sonic wave more accurately.

According to a first embodiment of the present disclosure, the control module is further configured for controlling the first sonic wave transceiver to transmit the first sonic wave, and controlling the second sonic wave transceiver to transmit the second sonic wave or controlling the first sonic wave transceiver to transmit the first sonic wave again in accordance with whether the first sonic wave transceiver receives the first reflected sonic wave. A transmission path of the first sonic wave at least partially overlaps a transmission path of the second sonic wave.

According to a first embodiment of the present disclosure, the first sonic wave includes a vertical beam angle in a vertical direction perpendicular to the display screen. The vertical beam angle is from 15 to 40 degrees.

According to a first embodiment of the present disclosure, the first sonic wave includes a horizontal beam angle in a horizontal direction parallel with the display screen. The horizontal beam angle is from 80 to 100 degrees.

According to a first embodiment of the present disclosure, the first sonic wave transceiver has a transmitting terminal configured for generating the first sonic wave. The first sonic wave transceiver further include a sound absorbing material extending from the transmitting terminal and elongated along a propagation direction of the first sonic wave.

According to a first embodiment of the present disclosure, the control module is further configured for monitoring whether an intensity of the first reflected sonic wave is greater than or equal to a threshold value. When the intensity of the first reflected sonic wave is greater than or equal to the threshold value, the control module interrupts monitoring of the intensity of the first reflected sonic wave, and calculates a distance of the object relative to the first sonic wave transceiver in accordance with a time at which the intensity of the first reflected sonic wave is greater than or equal to the threshold value and a time at which the first sonic wave is transmitted.

Another aspect of the present disclosure is to provide a sensing device. The sensing device is configured to mount around a display module to detect an object. The display module has a display screen for displaying an image. The sensing device includes a first sonic wave transceiver, a second sonic wave transceiver, and a control module. The first sonic wave transceiver is configured for transmitting a first sonic wave. The second sonic wave transceiver is configured for transmitting a second sonic wave. The first sonic wave transceiver and the second sonic wave transceiver are further configured for receiving a first reflected sonic wave and a second reflected sonic wave generated based on the first sonic wave and the second sonic wave, respectively. The first sonic wave includes a vertical beam angle in a vertical direction perpendicular to the display screen. The vertical beam angle is from 15 to 40 degrees. The control module is electrically coupled to the first sonic wave transceiver and the second sonic wave transceiver, and the control module is configured for controlling the first sonic wave transceiver and the second sonic wave transceiver. The control module further calculates a position of the object relative to the display module based on the above first reflected sonic wave and a second reflected sonic wave. By setting the above vertical beam angle, the present embodiment sensing device is allowed to have a more accurate detection distance to avoid misjudgments.

According to a second embodiment of the present disclosure, the first sonic wave includes a horizontal beam angle in a horizontal direction parallel with the display screen. The horizontal beam angle is from 80 to 100 degrees.

According to a second embodiment of the present disclosure, the control module is further configured for controlling the first sonic wave transceiver to transmit the first sonic wave, and controlling the second sonic wave transceiver to transmit the second sonic wave or controlling the first sonic wave transceiver to transmit the first sonic wave again depending on whether the first sonic wave transceiver receives the first reflected sonic wave. A transmission path of the first sonic wave at least partially overlaps a transmission path of the second sonic wave.

According to a second embodiment of the present disclosure, the control module is further configured for monitoring whether an intensity of the first reflected sonic wave is greater than or equal to a threshold value. When the intensity of the first reflected sonic wave is greater than or equal to the threshold value, the control module interrupts monitoring of the intensity of the first reflected sonic wave, and calculates a distance of the object relative to the first sonic wave transceiver in accordance with a time at which the intensity of the first reflected sonic wave is greater than or equal to the threshold value and a time at which the first sonic wave is transmitted.

According to a second embodiment of the present disclosure, the first sonic wave transceiver has a transmitting terminal configured for generating the first sonic wave. The first sonic wave transceiver further includes a sound absorbing material extending from the transmitting terminal and elongated along a propagation direction of the first sonic wave.

Yet one aspect of the present disclosure further provides a sensing device. The sensing device is configured to mount around a display module to detect an object. The display module includes a display screen for displaying an image. The sensing device comprises a first sonic wave transceiver, a second sonic wave transceiver, and a control module. The first sonic wave transceiver is configured for transmitting a first sonic wave. The second sonic wave transceiver is configured for transmitting a second sonic wave. The first sonic wave transceiver and the second sonic wave transceiver are further configured for receiving a first reflected sonic wave and a second reflected sonic wave generated in accordance with the first sonic wave and the second sonic wave, respectively. The control module is electrically coupled to the first sonic wave transceiver and the second sonic wave transceiver, and the control module is configured for controlling the first sonic wave transceiver and the second sonic wave transceiver. The control module further calculates a position of the object relative to the display module in accordance with the above first reflected sonic wave and a second reflected sonic wave. The control module is further configured for controlling the first sonic wave transceiver to transmit the first sonic wave, and controlling the second sonic wave transceiver to transmit the second sonic wave or controlling the first sonic wave transceiver to transmit the first sonic wave again selectively depending on whether the first sonic wave transceiver receives the first reflected sonic wave. A transmission path of the first sonic wave at least partially overlaps a transmission path of the second sonic wave. The sensing device in the present embodiment can avoid the second sonic transceiver to transmit the second sonic wave redundantly.

According to a third embodiment of the present disclosure, the control module is further configured for monitoring whether an intensity of the first reflected sonic wave is greater than or equal to a threshold value. When the intensity of the first reflected sonic wave is greater than or equal to the threshold value, the control module interrupts monitoring of the intensity of the first reflected sonic wave, and calculates a distance of the object relative to the first sonic wave transceiver in accordance with a time at which the intensity of the first reflected sonic wave is greater than or equal to the threshold value and a time at which the first sonic wave is transmitted.

According to a third embodiment of the present disclosure, the first sonic wave includes a vertical beam angle in a vertical direction perpendicular to the display screen. The vertical beam angle is from 15 to 40 degrees.

According to a third embodiment of the present disclosure, the first sonic wave includes a horizontal beam angle in a horizontal direction parallel with the display screen. The horizontal beam angle is from 80 to 100 degrees.

According to a third embodiment of the present disclosure, the first sonic wave transceiver has a transmitting terminal configured for generating the first sonic wave. The first sonic wave transceiver further comprises a sound absorbing material extending from the transmitting terminal and elongated along a propagation direction of the first sonic wave.

According to a third embodiment of the present disclosure, a frequency of the first sonic wave and the second sonic wave is between 50 KHz and 70 KHz.

Yet another aspect of the invention provides a positioning method. The positioning method is used to position a relative position of an object on one side of a display screen. The positioning method includes the following steps: (a) disposing a first sonic wave transceiver and a second sonic wave transceiver around the display screen; (b) utilizing the first sonic wave transceiver and the second sonic wave transceiver to generate a first sonic wave and a second sonic wave, respectively, and a frequency of the first sonic wave and the second sonic wave being set between 50 KHz and 70 KHz; and (c) calculating the position of the object relative to the display screen in accordance with a first reflected sonic wave and a second reflected sonic wave generated in accordance with the first sonic wave and the second sonic wave.

In summary, the technical solution of the present disclosure has obvious advantages and beneficial effects as compared with the prior art. Through the above technical solution, considerable advances in technology and extensive industrial applicability can be achieved. The sensing device and positioning method provided by the present disclosure have a high detection update rate and are suitable to be applied to the touch application for large-sized panels.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic diagram of a sensing device according to one embodiment of the present disclosure;

FIG. 2A is a graph illustrating curves of frequency of a first and second sonic waves versus reflection intensity by different materials according to one embodiment of the present disclosure;

FIG. 2B is a schematic diagram of a vertical beam angle of a first sonic wave according to one embodiment of the present disclosure;

FIG. 2C is a schematic diagram of a horizontal beam angle of a first sonic wave according to one embodiment of the present disclosure;

FIG. 2D is a graph illustrating a relation between a frequency of a first and second sonic waves versus a vertical beam angle according to one embodiment of the present disclosure;

FIG. 3A and FIG. 3B are flow charts illustrating positioning calculation of a sensing device according to one embodiment of the present disclosure;

FIG. 4 is a waveform graph of a operation of the first sonic wave transceiver according to one embodiment of the present disclosure;

FIG. 5 is a schematic diagram of a structure of a first sonic wave transceiver according to one embodiment of the present disclosure; and

FIG. 6 is a flow chart of a positioning method 600 according to one embodiment of the present disclosure.

### DESCRIPTION OF THE EMBODIMENTS

Reference will now be made in detail to the present embodiments of the invention, examples of which are illustrated in the accompanying drawings. However, the embodiments provided herein are intended as illustrative only since numerous modifications and variations therein will be apparent to those skilled in the art. Description of the operation does not intend to limit the operation sequence. Any devices resulting from recombination of components with equivalent effects are within the scope of the present invention. In addition, drawings are only for the purpose of illustration and not plotted according to the original size. Wherever possible, the same reference numbers are used in the drawings and the description to refer to the same or like parts.

As used herein, “the first”, “the second”, . . . etc. do not refer to the order or priority, nor are they intended to limit the invention. They are merely used to distinguish the devices or operations described with the same technical terms.

As used herein, “around”, “about”, or “approximately” shall generally mean within 20 percent, preferably within 10 percent, and more preferably within 5 percent of a given value or range. Numerical quantities given herein are approximate, meaning that the term “around,” “about” or “approximately” can be inferred if not expressly stated.

As used herein, both “couple” and “connect” refer to direct physical contact or electrical contact or indirect physical contact or electrical contact between two or more components. Or they can also refer to reciprocal operations or actions between two or more components.

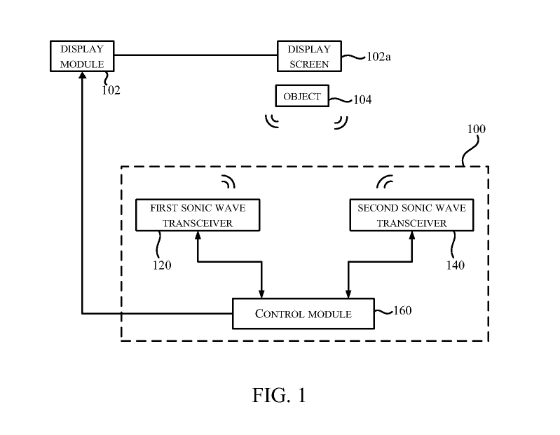

FIG. 1 is a schematic diagram of a sensing device 100 according to one embodiment of present disclosure. As shown in FIG. 1, the sensing device 100 is configured to mount around a display module 102 to detect an object 104. The display module 102 includes a display screen 102a for displaying an image.

The object 104 may be a palm or a finger of a user, a stylus pen, or any other indicator being operated by a user. The sensing device 100 can detect a relative position/coordinate of the palm above the display screen 102a by using a sonic wave method when the user performs a touch operation, so that a touch control corresponding to the touch operation is performed on the display module 102. With such the method, users are able to perform touch operations in a contactless manner (i.e., the object 104 does not need to actually touch the display screen 102a) or a contact manner.

A number of embodiments are shown as following paragraphs. However, it should be understood that such description is only for illustration of functions and applications of the above sensing device 100 and not to limit the scope of the invention.

As shown in FIG. 1, the sensing device 100 includes a first sonic wave transceiver 120, a second sonic wave transceiver 140, and a control module 160. The first sonic wave transceiver 120 is configured for transmitting a first sonic wave. The second sonic wave transceiver 140 is configured for transmitting a second sonic wave. The first sonic wave transceiver 120 and the second sonic wave transceiver 140 are further configured for receiving a first reflected sonic wave generated in accordance with the first sonic wave and a second reflected sonic wave generated in accordance with the second sonic wave. The control module 160 is configured for controlling the first sonic wave transceiver 120 and the second sonic wave transceiver 140. The control module 160 further calculates a position of the object 104 relative to the display module 102 in accordance with the above first reflected sonic wave and the second reflected sonic wave.

For example, the control module 160 may control the first sonic wave transceiver 120 and the second sonic wave transceiver 140 to generate the above-mentioned first sonic wave and second sonic wave, and the first and second sonic waves are reflected by the object 104 to generate the first reflected sonic wave and the second reflected sonic wave, respectively. The control module 160 receives the first reflected sonic wave and the second reflected sonic wave through the first sonic wave transceiver 120 and the second sonic wave transceiver 140, and calculates the relative position of the object 104 based on the first reflected sonic wave and the received second reflected sonic wave. A transmitting terminal and a receiving terminal of each of the first sonic wave transceiver 120 and the second sonic wave transceiver 140 may be integrated together or disposed separately.

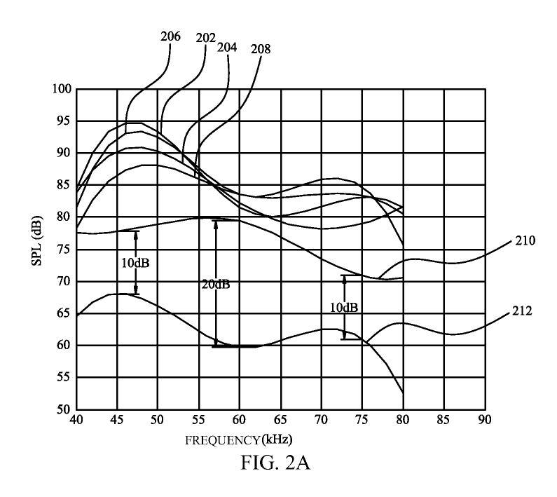

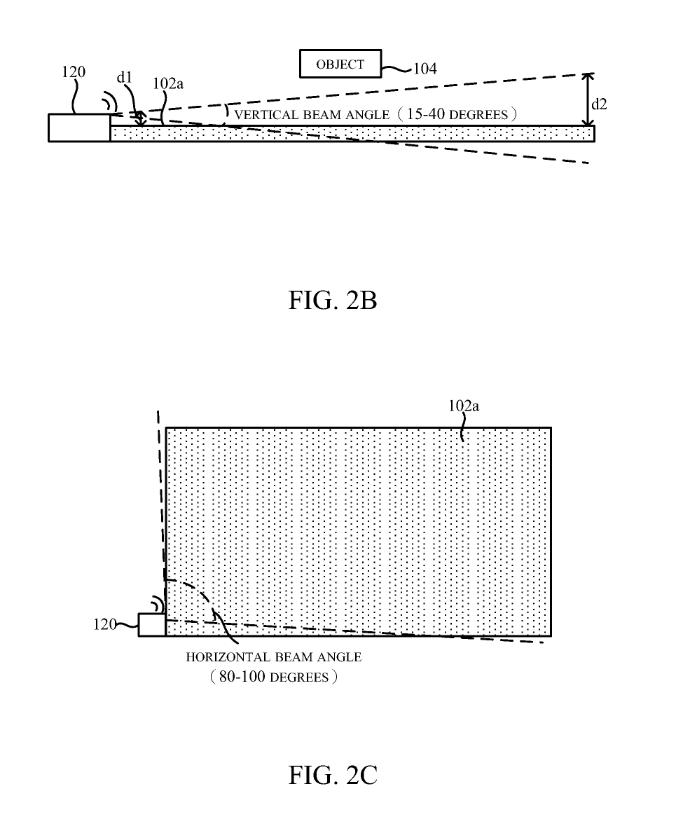

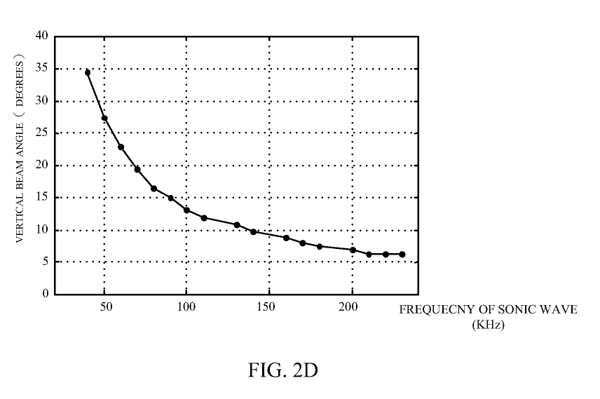

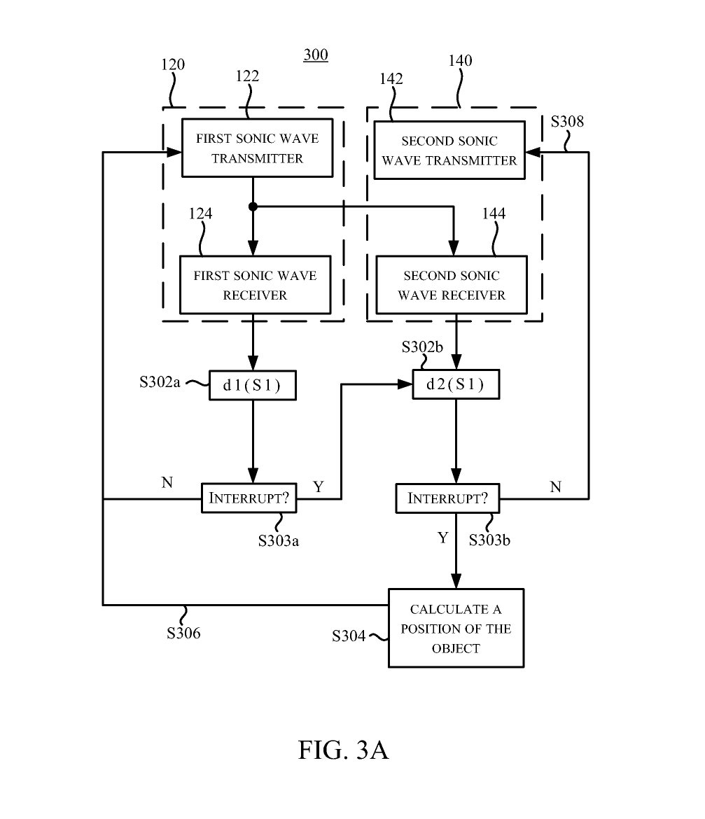

FIG. 2A is a graph illustrating curves of frequency of a first and second sonic waves versus reflection intensity by different materials according to one embodiment of the present disclosure. Since the first sonic wave has the same physical characteristics as the second sonic wave, a single curve is depicted in FIG. 2A to represent both the first sonic wave and the second sonic wave. When a sound pressure level (SPL) of the first and second reflected sonic waves generated by reflecting the above-mentioned first and second sonic waves by the object 104 has a certain degree of difference from a sound pressure level of sonic waves generated by reflecting the first and second sonic waves by air, the first sonic wave transceiver 120 and the second sonic wave transceiver 140 are allowed to receive the first reflected sonic wave and the second reflected sonic wave reflected from the object 104 accurately. Thus, the control module 160 is able to calculate the relative position of the object 104 correctly. As shown in FIG. 2A, the first and the second reflected sonic waves generated by reflecting the above-mentioned first and second sonic waves by the object 104 made of different materials (e.g., sound-pressure-level curves 202, 204, 206, 208, 210, 212 respectively indicates that the first and second sonic waves are reflected by glass, sponge, aluminum, polypropylene, palm, and air) have different sound pressure levels.

Typically, most of the touch controls are performed using palms or fingers of users in current touch applications. Hence, as shown in FIG. 2A, in this embodiment, a frequency of the first and second sonic waves is set between about 50 KHz and about 70 KHz, and a difference between a sound pressure level of sonic waves generated by reflecting the first and second sonic waves by the palm and the sound pressure level of the sonic waves generated by reflecting the first and second sonic waves by air is approximately 20 dB. When compared with the ultrasonic transceiver used in some approaches in which a frequency of a generated sonic wave is mostly set to 48 KHz or 75 KHz. A difference between the sound pressure level of the sonic wave generated by reflecting the sonic wave having the frequency of 48 KHz or 75 KHz by the palm and a sound pressure level of a sonic wave generated by reflecting the sonic wave having the frequency of 48 KHz or 75 KHz by air is only approximately 10 dB. As a result, when the frequency of the first and second sonic waves is set between about 50 KHz and about 70 KHz, the first sonic wave transceiver 120 and the second sonic wave transceiver 140 can receive the first and second reflected sonic waves more accurately. In some embodiments, the frequency of the first and second sonic waves is set greater than 50 KHz, and less than or equal to 70 KHz. In some other embodiments, the frequency of the first and second sonic waves is set between about 55 KHz and about 65 KHz. In yet some other embodiment, the frequency of the first and second sonic waves is set between about 55 KHz and about 60 KHz, such as 57 KHz.

FIG. 2B is a schematic diagram of a vertical beam angle of a first sonic wave according to one embodiment of the present disclosure. FIG. 2C is a schematic diagram of a horizontal beam angle of a first sonic wave according to one embodiment of the present disclosure. Generally speaking, a sonic wave signal is one signal having multiple beam angles that indicate different directivities. For example, as shown in FIG. 2B, the first sonic wave transmitted by the first sonic wave transceiver 120 includes a vertical beam angle in a vertical direction that is perpendicular to the display screen 102a. Alternatively, as shown in FIG. 2C, the first sonic wave includes a horizontal beam angle in a horizontal direction that is parallel with the display screen 102a.

In typical applications, the larger the horizontal beam angle is, the greater the horizontal moving distance of the object 104 being detectable by the sensing device 100 is. This circumstance is applicable to the display screen 102a having a large area (such as a large-sized display panel). However, the larger the vertical beam angle is, the greater the minimum vertical distance d1 and the maximum vertical distance d2 of the object 104 relative to the display screen 102a are, which probably causes misjudgments of the sensing device 100. For example, in typical touch applications, the sensing device 100 will probably determine that an accidental finger touch by a user to be a normal touch control if the vertical beam angle is excessively large, and an unnecessary touch operation is thus generated.

FIG. 2D is a graph illustrating a relation between a frequency of a first and second sonic waves and a vertical beam angle according to one embodiment of the present disclosure. In FIG. 2D, the beam angle is defined as the beam angle measured when energies of sonic waves decays to half of their original values. Similarly, since the first sonic wave has the same physical characteristics as the second sonic wave, a single curve is depicted in FIG. 2D to represent both the first sonic wave and the second sonic wave. Generally speaking, the higher the frequency of the first and second sonic waves is, the smaller the beam angles corresponding to the frequency that indicate different directivities are. Therefore, in considering the trade-off between frequency, horizontal beam angle, and vertical beam angle, the frequency of the first and second sonic waves generated by the first sonic wave transceiver 120 and the second sonic wave transceiver 140 can be set between about 50 KHz and about 70 KHz as described in the above-mentioned embodiment. As shown in FIG. 2D, the vertical beam angle of the first and second sonic waves having the frequency set between about 50 KHz and about 70 KHz in the vertical direction perpendicular to the display screen 102a is from about 15 to about 40 degrees (see FIG. 2B). In some embodiments, the vertical beam angle of the first and second sonic waves having the frequency set between about 50 KHz and about 70 KHz in the vertical direction perpendicular to the display screen 102a is more preferably from about 20 to about 35 degrees. In some other embodiments, the vertical beam angle of the first and second sonic waves having the frequency set between about 50 KHz and about 70 KHz in the vertical direction perpendicular to the display screen 102a is further more preferably from about 25 to about 30 degrees. In addition, the horizontal beam angle of the above first and second sonic waves in the horizontal direction parallel with the display screen 102a is from about 80 to about 100 degrees. In some embodiments, the horizontal beam angle of the above first and second sonic waves in the horizontal direction parallel with the display screen 102a is more preferably from about 85 degrees to about 95 degrees. In some other embodiments, the horizontal beam angle of the above first and second sonic waves in the horizontal direction parallel with the display screen 102a is further more preferably about 90 degrees (see FIG. 2C).

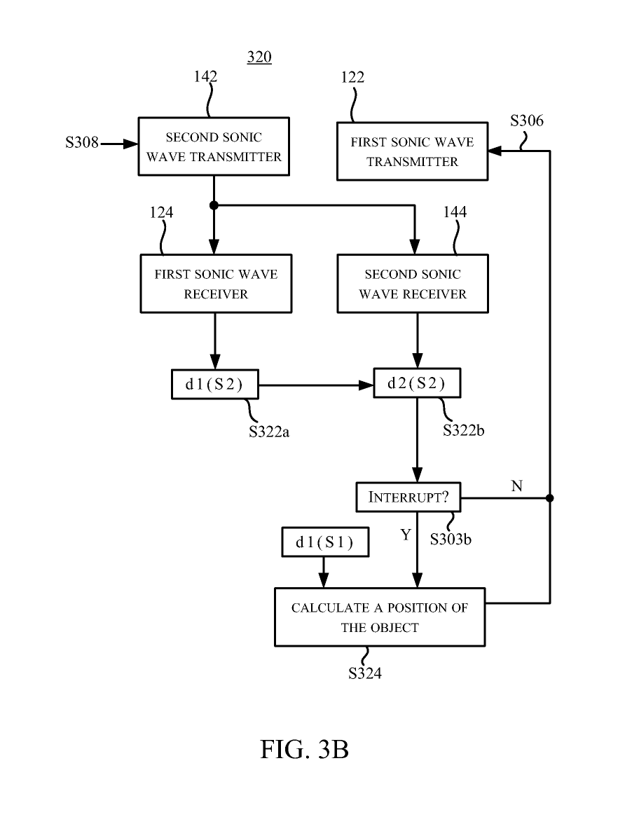

FIG. 3A to FIG. 3B are flow charts illustrating positioning calculation of a sensing device 100 according to one embodiment of the present disclosure. In the present embodiment, the control module 160 is further configured for controlling the first sonic wave transceiver 120 to transmit the first sonic wave, and controlling the second sonic wave transceiver 140 to transmit the second sonic wave or controlling the first sonic wave transceiver 120 to transmit the first sonic wave again in accordance with whether the first sonic wave transceiver 120 receives the first reflected sonic wave. A transmission path of the first sonic wave at least partially overlaps the transmission path of the second sonic wave. Because the position of a same object is calculated through the first sonic wave transceiver 120 and the second sonic wave transceiver 140, the position of the object cannot be estimated correctly if only a position of the object relative to the single sonic wave transceiver is obtained. Hence, if the first sonic wave transceiver 120 does not receive the first reflected sonic wave, the control module 160 controls the first sonic wave transceiver 120 to transmit the first sonic wave again. Only when the second sonic wave transceiver 140 does not receive the first reflected sonic wave, the control module 160 will control the second sonic wave transceiver 140 to transmit the second sonic wave to obtain the position of the object relative to the second sonic wave transceiver 140. As a result, the redundant transmission of the second sonic wave by the second sonic wave transceiver 140 is avoided.

In order to provide a clear explanation, a single sonic wave transceiver is depicted as a sonic wave transmitter and a sonic wave receiver in FIG. 3A. For illustration, as shown in FIG. 3A, the control module 160 controls the first sonic wave transmitter 122 in the first sonic wave transceiver 120 to generate the first sonic wave, and the first sonic wave is reflected by the object 104 to generate the first reflected sonic wave. If the first sonic wave receiver 124 receives the first reflected sonic wave, the control module 160 records a time period between transmission of the first sonic wave and reception of the first reflected sonic wave by the first sonic wave transceiver 120 as t1, and calculates a distance of the first sonic wave transceiver 120 relative to the object 104 d1(S1) according to the following equation (1) (i.e., step S302a shown in FIG. 3A):

d1(S1)=(V*t1)/2 (1)

In the equation (1), d1(S1) denotes the distance measured by the first sonic wave transceiver 120 using the first sonic wave, V denotes a wave velocity of a sonic wave signal. Generally speaking, V is about 340 meters per second (m/s). After the distance d1(S1) is calculated, the control module 160 interrupts an operation of the first sonic wave receiver 124 (i.e., step S303a shown in FIG. 3A). After that, if a second sonic wave receiver 144 also receives the first reflected sonic wave, the control module 160 records a time period between transmission of the first sonic wave and reception of the first reflected sonic wave by the second sonic wave transceiver 140 as t2, and calculates a distance of the second sonic wave transceiver 140 relative to the object 104 d2(S1) according to the following equation (2) (i.e., step S302b shown in FIG. 3A):

d2(S1)=V*t2−d1(S1) (2)

The control module 160 further calculates a position of the object 104 relative to the display module 102 using the above equations (1) and (2) (i.e., step S304 shown in FIG. 3A). Then, the control module 160 controls the first sonic transceiver 120 to transmit the first sonic wave, so as to perform the next sensing operation (i.e., step S306 shown in FIG. 3A).

However, as shown in FIG. 3B, if the second sonic wave receiver 144 does not receive the first reflected sonic wave, the control module 160 cannot calculate the distance d2(S1). Then, the control module 160 further selects to control the second sonic wave transmitter 142 to transmit the second sonic wave (i.e., step S308 shown in FIG. 3B). The second sonic wave is reflected by the object 104 to generate a second reflected sonic wave. When both the first sonic wave receiver 124 and the second sonic wave receiver 144 receive the second reflected sonic wave, the control module 160 records a time period between transmission of the second sonic wave and reception of the second reflected sonic wave by the first sonic wave transceiver 120 as t3, and records a time period between transmission of the second sonic wave and reception of the second reflected sonic wave by the second sonic wave transceiver 140 as t4. The control module 160 also respectively calculates a distance of the first sonic wave transceiver 120 relative to the object 104 d1(S2) according to the following equation (3) (i.e., step S322a shown in FIG. 3B) and a distance of the second sonic wave transceiver 140 relative to the object 104 d2(S2) according to the following equation (4) (i.e., step S322b shown in FIG. 3B):

d1(S2)=V*t3−d2(S2) (3)

d2(S2)=(V*t4)/2 (4)

The control module 160 further combines the above equations (1), (3), and e(4) to obtain the following equation (5):

d1=α*d1(S1)+(1−α)*d1(S2). (5)

Where α denotes a distance-weighted index which can be adjusted based on a distance of the first sonic wave transceiver 120 relative to the display module 102 and a distance of the second sonic wave transceiver 140 relative to the display module 102 correspondingly, and 0≦α≦1. In the present embodiment, the control module 160 may calculate a position of the object 104 relative to the display module 102 according to equations (4) and (5) (i.e., step S324 shown in FIG. 3B). After that, the control module 160 controls the first sonic wave transceiver 120 to retransmit the first sonic wave, so as to perform the next sensing operation (i.e., step S306 shown in FIG. 3A). Compared with the prior art in which the number of the sonic wave transceivers is larger than that utilized in the present disclosure, the positioning calculation method proposed by the present disclosure has a lower operational complexity, and the speed of positioning calculation process is thus improved.

In the above-mentioned embodiment, the control module 160 can further determine whether the first sonic wave receiver 124 and the second sonic wave receiver 144 receive the first reflected sonic wave or the second reflected sonic wave by setting an interrupt time. For illustration, if the maximum detectable distance of the sensing device 100 is about 50 centimeters (cm), and a wave velocity of the first sonic wave and the second sonic wave is supposed to be about 340 m/s, then the longest time taken to transmit and reflect the sonic wave is about 0.5*2/340=2.94 milliseconds (ms). Hence, the control module 160 may set the interrupt time to about 2.94 ms. If the first sonic wave receiver 124 and the second sonic wave receiver 144 have not received the first reflected sonic wave or the second reflected sonic wave after exceeding 2.94 ms, the control module 160 controls the first sonic wave transceiver 120 or the second sonic wave transceiver 140 to retransmit the sonic wave in a real-time manner. Thus, the detection update rate of the sensing device 100 is increased.

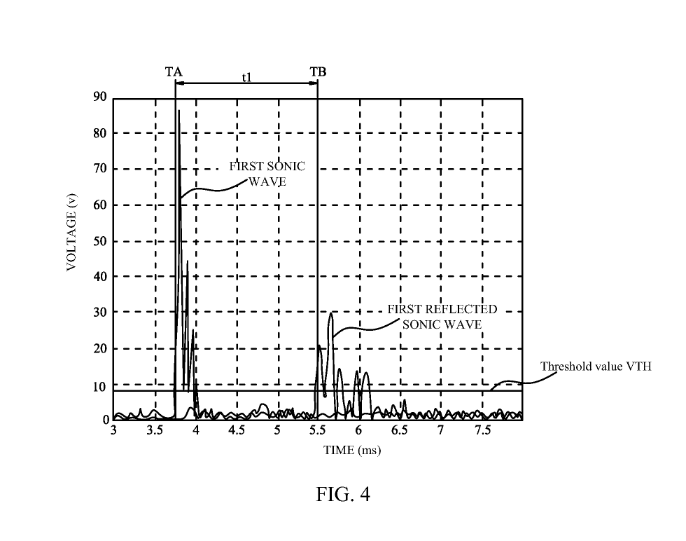

FIG. 4 is a waveform graph illustrating operation of the first sonic wave transceiver according to one embodiment of the present disclosure. Except for setting the interrupt time, the control module 160 may be further configured for monitoring whether an intensity of the first reflected sonic wave is greater than or equal to a threshold value VTH. When the intensity of the first reflected sonic wave is greater than or equal to the threshold value VTH, the control module 160 interrupts monitoring of the intensity of the first reflected sonic wave, and calculates a distance of the object 104 relative to the first sonic wave transceiver 120 in accordance with a time at which the intensity of the first reflected sonic wave is greater than or equal to the threshold value VTH and a time at which the first sonic wave is transmitted.

For illustration, as shown in FIG. 4, the first sonic wave transceiver 120 transmits the first sonic wave at a time TA, and the control module 160 detects that the intensity of the first reflected sonic wave received by the first sonic wave receiver 122 is greater than the threshold value VTH at a time TB. The control module 160 thus determines that the first sonic wave receiver 122 has received the first reflected sonic wave correctly. As a result, the control module 160 calculates the distance of the first sonic wave transceiver 120 relative to the object 104 d1(S1) based on a time difference between TA and TB (such as t1 in the above equation (1)). Similarly, the same configuration may be set for the second reflected sonic wave, and a description in this regard is not provided. Typically, the above threshold value may be adjusted depending on the actual environment. The threshold value must be greater than the environment noise of the actual environment, so as to avoid that the control module 160 mistakes the environment noise for the first or the second reflected sonic wave. As compared with the prior art in which each of the sonic wave transceivers must receive the individual sonic signal reflected from the object, the control module 160 is allowed to interrupt the sensing operation of the first sonic wave transceiver 120 or the second sonic wave transceiver 140 in a real-time manner, when the intensity of first reflected sonic wave or the intensity of the second reflected sonic wave received by the first sonic wave transceiver 120 or the second sonic wave transceiver 140 is greater than the threshold value, by setting the threshold value VTH according to the present embodiment. In this manner, the control module 160 is able to improve its speed of determining whether the first sonic wave transceiver 120 and the second sonic wave transceiver 140 have received the first or the second reflected sonic wave correctly, and the process speed when calculating the position of the object 104 is father improved. As a result, the detection update rate of the sensing device 100 is effectively improved.

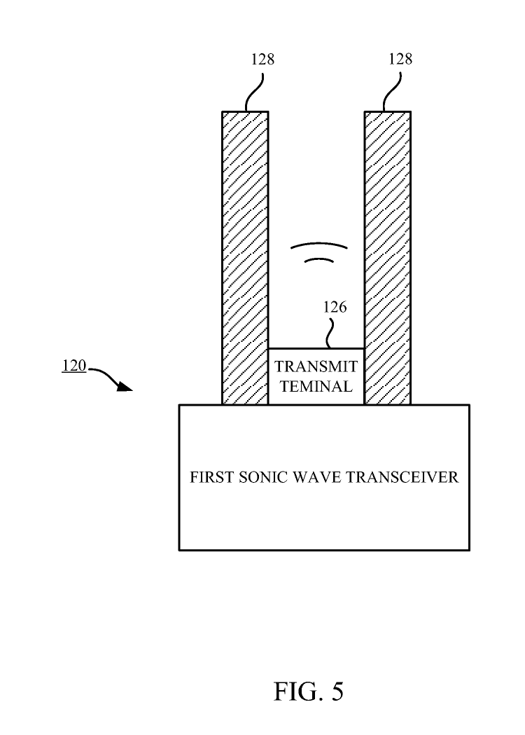

FIG. 5 is a schematic diagram of a structure of a first sonic wave transceiver according to one embodiment of the present disclosure. In the present embodiment, the first sonic wave transceiver 120 has a transmitting terminal 126 and sound absorbing materials 128. The transmitting terminal 126 is configured for generating the above-mentioned first sonic wave. The sound absorbing materials 128 extend from the transmitting terminal 126 and are elongated along a propagation direction of the first sonic wave. For example, the acoustic absorbing materials 128 may be acoustic boards or acoustic absorbers, and are disposed on two sides of the transmitting terminal 126. Hence, the first sonic wave transceiver 120 may further reduce the above-mentioned vertical beam angle so as to improve the accuracy of the sensing device 100. Likewise, the second sonic wave transceiver 140 may have the same structure.

It is should be noticed that there are two sonic wave transceivers in each of the above-mentioned embodiments. However, the sensing device 100 may further include numerous sonic wave transceivers, and calculates the position of the object 104 according to the positioning calculation flows 300, 320 shown in FIG. 3A and FIG. 3B. Those of ordinary skill in the art may adjust the number of the sonic wave transceivers as required by the actual application environment, and the present invention is not limited in this regard.

In addition, the above control module 100 may be implemented in software or hardware/firmware. For illustration, if execution speed and accuracy are both the first considerations, the control module 160 may be basically implemented in hardware. For example, the control module 160 may be a processing unit or a field-programmable gate array (FPGA). If design flexibility is the first consideration, the control module 160 may be basically implemented in software. However, the present disclosure is not limited in this regard, those of ordinary skill in the art may flexibly select the implementation method for the control module 160 as required.

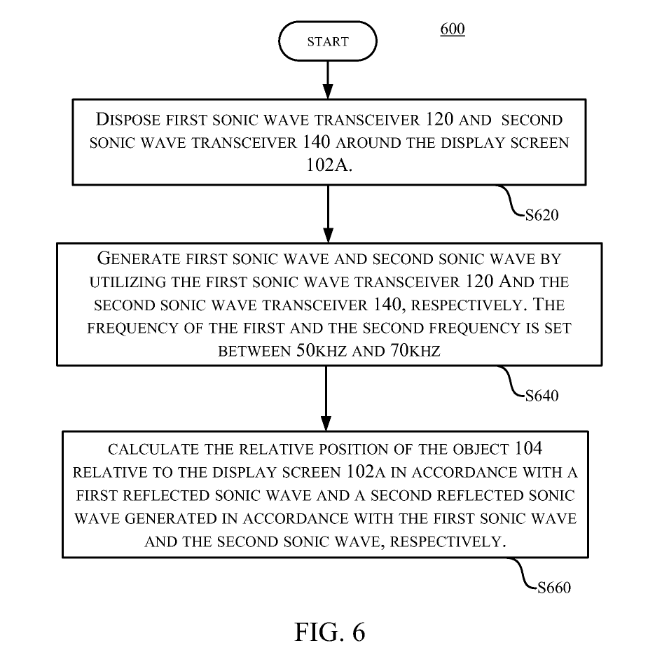

Another aspect of the present invention provides a positioning method. The positioning method is used to position a relative position of an object on one side of a display screen (such as the object 104 and the display screen 102a shown in FIG. 1). FIG. 6 is a flow chart of a positioning method 600 according to one embodiment of the present disclosure. As shown in FIG. 6, the positioning method 600 comprises a step S620, a step S640, and a step S660.

In step S620, the first sonic wave transceiver 120 and the second sonic wave transceiver 140 are disposed around the display screen 102a, as shown in FIG. 1.

In step S640, the first sonic wave transceiver 120 and the second sonic wave transceiver 140 are utilize to respectively generate a first sonic wave and a second sonic wave. As described previously, the frequency of the first sonic wave and the second sonic wave may be set between about 50 KHz and about 70 KHz. The vertical beam angle of the first and second sonic waves in the vertical direction perpendicular to the display screen 102a is from about 15 to about 40 degrees (see FIG. 2B). In addition, the above-mentioned horizontal beam angle of the first and second sonic waves in the horizontal direction parallel with the display screen 102a is from about 80 to about 100 degrees.

In step S660, a position of the object 104 relative to the display screen 102a is calculated based on a first reflected sonic wave and a second reflected sonic wave generated by reflecting the first sonic wave and the second sonic wave. In step S660, the second sonic wave transceiver 140 may further transmit the second sonic wave or the first sonic wave transceiver 120 may further transmit the first sonic wave again depending on whether the first sonic wave transceiver 120 receives the first reflected sonic wave. In addition, a transmission path of the first sonic wave at least partially overlaps a transmission path of the second sonic wave. The relative position of the object 104 can be calculated, for example, according the above equations (1)-(5) and the above operation flows shown in FIG. 3A and FIG. 3B.

Similarly, the step S660 can be performed by monitoring whether an intensity of the first reflected sonic wave is greater than or equal to a threshold value VTH, as shown in FIG. 4. When the intensity of the first reflected sonic wave is greater than or equal to a threshold value VTH, interrupt the monitoring of the intensity of the first reflected sonic wave and calculate a distance of the object 104 relative to the first sonic wave transceiver 120 based on a time at which the intensity of the first reflected sonic wave is greater than or equal to the threshold value VTH and a time at which the first sonic wave is transmitted.

In summary, the present disclosure discloses the sensing device and the positioning method that have a higher accuracy and a higher detection rate than the prior art device and method when applied to detecting palms of users. In addition, the sensing device and positioning method in the present disclosure are suitable to be applied to the touch application for large-sized panels.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A sensing device configured to mount around a display module to detect an object, the display module having a display screen for displaying an image, the sensing device comprising:
a first sonic wave transceiver and a second sonic wave transceiver respectively configured for transmitting a first sonic wave and a second sonic wave and receiving a first reflected sonic wave and a second reflected sonic wave generated in accordance with the first sonic wave and the second sonic wave, respectively, and a frequency of the first sonic wave and the second sonic wave being between 50 KHz and 70 KHz; and
a control module electrically coupled to the first sonic wave transceiver and the second sonic wave transceiver, the control module being configured for controlling the first sonic wave transceiver and the second sonic wave transceiver, and for calculating a position of the object relative to the display module in accordance with the first reflected sonic wave and a second reflected sonic wave.

2. The sensing device of claim 1, wherein the control module is further configured for controlling the first sonic wave transceiver to transmit the first sonic wave, and controlling the second sonic wave transceiver to transmit the second sonic wave or controlling the first sonic wave transceiver to transmit the first sonic wave again in accordance with whether the first sonic wave transceiver receives the first reflected sonic wave, and a transmission path of the first sonic wave at least partially overlaps a transmission path of the second sonic wave.

3. The sensing device of claim 1, wherein the first sonic wave comprises a vertical beam angle in a vertical direction perpendicular to the display screen, and the vertical beam angle is from 15 to 40 degrees.

4. The sensing device of claim 3, wherein the control module is further configured for controlling the first sonic wave transceiver to transmit the first sonic wave, and controlling the second sonic wave transceiver to transmit the second sonic wave or controlling the first sonic wave transceiver to transmit the first sonic wave again in accordance with whether the first sonic wave transceiver receives the first reflected sonic wave, and a transmission path of the first sonic wave at least partially overlaps a transmission path of the second sonic wave.

5. The sensing device of claim 1, wherein the first sonic wave comprises a horizontal beam angle in a horizontal direction parallel with the display screen, and the horizontal beam angle is from 80 to 100 degrees.

6. The sensing device of claim 5, wherein the control module is further configured for controlling the first sonic wave transceiver to transmit the first sonic wave, and controlling the second sonic wave transceiver to transmit the second sonic wave or controlling the first sonic wave transceiver to transmit the first sonic wave again in accordance with whether the first sonic wave transceiver receives the first reflected sonic wave, and a transmission path of the first sonic wave at least partially overlaps a transmission path of the second sonic wave.

7. The sensing device of claim 6, wherein the first sonic wave transceiver comprises a transmitting terminal configured for generating the first sonic wave, the first sonic wave transceiver further comprises a sound absorbing material extending from the transmitting terminal and elongated along a propagation direction of the first sonic wave.

8. The sensing device of claim 1, wherein the control module is further configured for monitoring whether an intensity of the first reflected sonic wave is greater than or equal to a threshold value, when the intensity of the first reflected sonic wave is greater than or equal to the threshold value, the control module interrupts monitoring of the intensity of the first reflected sonic wave and calculates a distance of the object relative to the first sonic wave transceiver in accordance with a time at which the intensity of the first reflected sonic wave is greater than or equal to the threshold value and a time at which the first sonic wave is transmitted.

9. A positioning method utilized to position a relative position of an object on one side of a display screen, the positioning method comprising:
disposing a first sonic wave transceiver and a second sonic wave transceiver around the display screen;
utilizing the first sonic wave transceiver and the second sonic wave transceiver to generate a first sonic wave and a second sonic wave, respectively, wherein a frequency of the first sonic wave and the second sonic wave is between 50 KHz and 70 KHz; and
calculating the relative position of the object relative to the display screen in accordance with a first reflected sonic wave and a second reflected sonic wave generated in accordance with the first sonic wave and the second sonic wave, respectively.

10. The positioning method of claim 9, further comprising:
controlling the second sonic wave transceiver to transmit the second sonic wave or controlling the first sonic wave transceiver to transmit the first sonic wave again in accordance with whether the first sonic wave transceiver receives the first reflected sonic wave, and a transmission path of the first sonic wave at least partially overlapping a transmission path of the second sonic wave.

11. The positioning method of claim 9, wherein the first sonic wave comprises a vertical beam angle in a vertical direction perpendicular to the display screen, and the vertical beam angle is from 15 to 40 degrees.

12. The positioning method of claim 11, further comprising:
controlling the second sonic wave transceiver to transmit the second sonic wave or controlling the first sonic wave transceiver to transmit the first sonic wave again in accordance with whether the first sonic wave transceiver receives the first reflected sonic wave, and a transmission path of the first sonic wave at least partially overlapping a transmission path of the second sonic wave.

13. The positioning method of claim 11, wherein the first sonic wave comprises a horizontal beam angle in a horizontal direction parallel with the display screen, and the horizontal beam angle is from 80 to 100 degrees.

14. The positioning method of claim 13, further comprising:
controlling the second sonic wave transceiver to transmit the second sonic wave or controlling the first sonic wave transceiver to transmit the first sonic wave again in accordance with whether the first sonic wave transceiver receives the first reflected sonic wave, and a transmission path of the first sonic wave at least partially overlapping a transmission path of the second sonic wave.

15. The positioning method of claim 9, further comprising:
monitoring whether an intensity of the first reflected sonic wave is greater than or equal to a threshold value, when the intensity of the first reflected sonic wave is greater than or equal to the threshold value, interrupting monitoring of the intensity of the first reflected sonic wave and calculating a distance of the object relative to the first sonic wave transceiver in accordance with a time at which the intensity of the first reflected sonic wave is greater than or equal to the threshold value and a time at which the first sonic wave is transmitted.

16. The positioning method of claim 9, further comprising:
disposing a sound absorbing material at a transmitting terminal of the first sonic wave transceiver, wherein the transmitting terminal is configured for generating the first sonic wave, and the acoustic absorbing materials extend from the transmitting terminal and are elongated along a propagation direction of the first sonic wave.

17. A sensing device configured to mount around a display module to detect an object, the display module having a display screen for displaying an image, the sensing device comprising:
a first sonic wave transceiver and a second sonic wave transceiver respectively configured for transmitting a first sonic wave and a second sonic wave and receiving a first reflected sonic wave and a second reflected sonic wave generated in accordance with the first sonic wave and the second sonic wave, respectively, wherein the first sonic wave comprises a vertical beam angle in a vertical direction perpendicular to the display screen, and the vertical beam angle is from 15 to 40 degrees; and
a control module electrically coupled to the first sonic wave transceiver and the second sonic wave transceiver, the control module being configured for controlling the first sonic wave transceiver and the second sonic wave transceiver, and calculating a position of the object relative to the display module in accordance with the first reflected sonic wave and a second reflected sonic wave.

18. The sensing device of claim 17, wherein the first sonic wave comprises a horizontal beam angle in a horizontal direction parallel with the display screen, and the horizontal beam angle is from 80 to 100 degrees.
